(19) United States
(12) Patent Application Publication
(10) Pub. No.: US 2024/0151279 A1
(43) Pub. Date: May 9, 2024

(54) METHOD FOR STANDSTILL CONTROL OF A MULTI-BODY SYSTEM

(71) Applicant: B&R INDUSTRIAL AUTOMATION GMBH, Eggelsberg (AT)

(72) Inventors: Joachim WEIßBACHER, Eggelsberg (AT); Helmut HERZOG, Eggelsberg (AT)

(73) Assignee: B&R INDUSTRIAL AUTOMATION GMBH, Eggelsberg (AT)

(21) Appl. No.: 18/503,682

(22) Filed: Nov. 7, 2023

(30) Foreign Application Priority Data
Nov. 8, 2022 (AT) A50851/2022

(51) Int. Cl. F16D 48/06

(52) U.S. Cl. CPC F16D 48/06; F16D 2500/70605

(57) ABSTRACT

A method for standstill control of a multi-body system (MKS) having at least one drive body and at least one friction body mechanically coupled to the drive body. A static friction acts on the friction body, a velocity of one of the bodies of the MKS is determined as measurement velocity subject to a measurement noise and converted in a dead zone element to a dead zone velocity. The dead zone velocity assumes the value of zero for values of the measurement velocity above a value of zero and below a positive dead zone limit, and assumes the value of the measurement velocity for values of the measurement velocity above the positive dead zone limit. The dead zone velocity is provided to a velocity controller as an actual velocity for controlling.

### CROSS-REFERENCE TO RELATED APPLICATION

This application claims priority under 35 U.S.C. § 119(a) to Austria Application No. A50851/2022 filed Nov. 8, 2022, the disclosure of which is expressly incorporated by reference herein in its entirety.

### BACKGROUND

### 1. Field of the Invention

The present invention relates to a method for standstill control of a multi-body system comprising at least one drive body and a friction body mechanically coupled to the drive body, wherein a velocity controller determines, from a specified target velocity v_{target}=0 and from an actual velocity of the multi-body system, a control variable for adjusting the actual velocity to the target velocity, wherein the control variable is converted by an actuator into a drive force acting on the drive body and wherein a static friction acts on the friction body.

### 2. Discussion of Background Information

Controlling velocities is a frequent task in the field of drive technology. The term “velocity” is to be interpreted broadly, so that, in the course of the following considerations, linear velocities, angular velocities, rotational speeds, path velocities, etc., are subsumed under the term “velocity”. In the present context, velocities are further interpreted as velocities of (mechanical) multi-body systems, wherein, in the context of this patent application, a multi-body system is understood to mean a mechanical system of individual bodies which are mechanically coupled to one another (e.g., by joints or force elements, such as springs or dampers) and which are under the influence of forces (e.g., forces generated by actuators or servomotors or electric motors). Examples of multi-body systems with velocities to be controlled can be internal combustion engines whose crankshaft speeds are to be controlled, electric machines whose rotor speeds are to be controlled, or drive trains driven in general by machines with several masses/inertias whose angular velocities are to be controlled.

A variety of requirements can be associated with the task, “velocity control of a multi-body system.” Often, the temporal shortening of transient processes, an increase in the robustness of (velocity) control loops with respect to disturbances, the reduction of the control energy used, or the suppression of vibrations and/or oscillations are demanded. It turns out that, when designing velocity controllers for meeting the above requirements, special attention must be paid to maintaining the stability of the resulting velocity control loops. Velocity controllers are known to be used to determine control variables for reducing control errors between velocities to be controlled and target velocities, which are specified for the velocities to be controlled. In a likewise known manner, control variables are typically forces such as drive forces, torques, or electrical currents or other physical forces which can be specified by a velocity controller, and which allow to influence a velocity to be controlled. If the stability of a velocity control loop is lost, undesirable or even damaging behavior can occur, such as oscillations or limit cycles arising in the velocity control loop, i.e., continuous oscillations with usually constant magnitude of an oscillating quantity, e.g., an oscillating velocity.

Due to the special relevance of the topic, “stability of velocity control loops,” the prior art offers a variety of relevant considerations. For example, DE 19742370 B4 teaches the control of an electrical power steering system of a vehicle, wherein highly accurate estimated values of a motor angular velocity are determined for improving the stability of the control, and a phase correction of a steering torque is carried out.

In contrast, EP 0473914 A2 shows a system for the closed-loop control of a positioning unit in a motor vehicle, wherein a target value to be controlled is influenced by a guide former, which in turn depends upon an estimated value of a variable to be controlled, in order to improve the dynamics of the system in different operating conditions without impairing the stability of the closed control loop.

However, the cited prior art does not sufficiently address the fact that, in the context of known approaches to velocity control, very often precise and consequently mathematically complex models are required in order to represent the dynamic behavior of a multi-body system to be controlled with high accuracy and, based upon this, to be able to design velocity controllers that ensure that the stability is maintained at all expected operating points of a velocity control loop. An important area in which exact modeling is often associated with special difficulties is friction, which can act on certain bodies of a multi-body system. Particularly with regard to the static friction typically acting in reality, it is often possible only with great effort to make accurate predictions with regard to the actually prevailing friction or frictional forces.

Surprisingly, it was found here that static friction acting on bodies of a multi-body system, which, however, are not driven by a drive force, e.g., by a drive force generated by an actuator for the purpose of velocity controlling, can lead to stability problems, especially in the area of standstill of the multi-body system. This circumstance can be explained in a comprehensible manner with the example of a velocity-controlled two-body system with two mechanically-coupled bodies. Specifically, for this purpose, a two-body system having a drive body is assumed, on which a drive force acts and which is connected to a friction body via a mechanical shaft connection, wherein, in turn, only a shaft force transmitted via the mechanical shaft connection and a non-negligible static friction act on the friction body.

Typically, a velocity controller is provided for such a velocity-controlled two-body system, which determines a velocity control error from a specified target velocity and from an actual velocity of the two-body system, for example, by calculating a difference, and a determines a control variable from the velocity control error, which control variable must act on the drive body to compensate for the control error in order to thus adjust the velocity to the target velocity. A drive force for adjusting the actual velocity to the target velocity is usually provided as a control variable, as a result of which the velocity control error is ideally brought to zero.

If a vanishing target velocity of v_{target}=0 is provided, then it is clear that the drive force required by the velocity controller disappears, i.e., becomes zero, if the actual velocity corresponds to the target velocity, i.e., in this specific case, is also zero. However, if the actual velocity is superimposed with measurement noise, as is usual in practice, the actual velocity never exactly assumes the value zero, even at a standstill, but, rather, fluctuates between values that are slightly different from zero. These values, which are slightly different from zero, have the consequence in standstill or near standstill of the multi-body system that velocity control errors continuously prevail in the velocity controller, which velocity control errors are only slightly different from zero, but nevertheless different from zero, from which the velocity controller determines actuating variables or drive forces different from zero.

Small drive forces determined and specified by the velocity controller subsequently result in shaft forces that are different from zero and which are transmitted via the mechanical shaft connection. If static friction now acts on the friction body of the multi-body system, which is different from the drive body, then it may happen in this scenario that the shaft forces transmitted via the mechanical coupling do not exceed the acting static friction. Despite drive force being different from zero, there is no movement of the friction body, and the friction body thus remains at a standstill. From the point of view of the controller, the friction body behaves like a body with infinitely high inertia or infinitely high mass.

However, if the velocity controller has been designed on the basis of the inertia of the friction body effective in normal operation, i.e., not in standstill, a significant deviation between model assumption for the controller design and real behavior results at standstill. The velocity controller was thus designed on the basis of a completely incorrect model. It is obvious that, in such a scenario, loss of stability can occur—in particular, considering that increases in the inertias or masses of the bodies of a multi-body system lead to a shift of resonant frequencies of the multi-body system in the direction of lower frequencies, wherewith, in many practical cases, an increase in the amplification in the resonant points is associated. In particular, this problem area associated with static friction is not discussed in the prior art.

### SUMMARY

Therefore, embodiments are directed to a robust method for the standstill control of a multi-body system subject to friction, by which stable operation of the multi-body system is ensured even without knowledge of an accurate model of the multi-body system.

For a method mentioned at the outset, this object is achieved by the features of the characteristics of the independent claims. The independent claims describe a method for standstill control of a multi-body system and a control loop.

Specifically, as mentioned at the outset, a multi-body system includes at least one drive body and at least one friction body mechanically coupled to the drive body is assumed, wherein a velocity controller determines, from a specified target velocity v_{target}=0 and from an actual velocity of the multi-body system, a control variable for adjusting the actual velocity to the target velocity, wherein the control variable is converted by an actuator into a drive force acting on the drive body, and a static friction acts on the friction body.

According to embodiments, a multi-body system of this type determines a velocity of one of the bodies of the multi-body system as a measurement velocity that is subject to a measurement noise and to feed it to a dead zone element. The dead zone element converts the measurement velocity to a dead zone velocity, which assumes the value zero for measurement velocity values above a value of zero and below a positive dead zone limit, and assumes the measurement velocity value for values above the positive dead zone limit. The positive dead zone limit is selected to be greater than a specified maximum value of the measurement noise of the measurement velocity, and the dead zone velocity is fed to the velocity controller as the actual velocity for controlling.

According to the method, the velocity control loop arising in the context of the velocity control is disconnected in cases in which a loss of stability can occur due to static friction. The use of a dead zone element represents an effective as well as simple measure, by which it becomes possible in a robust and sustainable manner to suppress the destabilizing effect of measurement noise at standstill. To implement this suppression, it is necessary to suitably parameterize the dead zone limits so that, in cases of a possible stability loss, no measurement noise remains in the feedback velocity signal as a destabilizing excitation, which is also ensured by the present invention. It should be emphasized that, by the dead zone element, the control loop is disconnected at a standstill and thus in cases in which usually no activity is required from a velocity controller anyway. Moreover, the dead zone element is easy to parameterize and can easily be introduced or integrated into already existing control structures.

With regard to determining a measurement velocity that is subject to measurement noise, which is necessary in the context of the invention, it should be noted that the specific type of determination is irrelevant for the invention. In fact, the measurement velocity that is subject to a measurement noise can be measured directly, or can also be determined or estimated from another measurement signal, e.g., from a measurement position, or from several measurement signals from one or more of the bodies of the multi-body system. In this case, the most varied output signals can be used as measurement signals of a body of the multi-body system, such as electrical currents or stresses or accelerations or forces acting on a body, and, in particular, different concepts of the control-engineering observer technology can be used, which contributes to a particular extent to the flexibility of the solution according to the invention.

Of course, the use of the disclosed embodiments is not limited to positive velocities. In an advantageous manner, a negative dead zone limit can also be provided in the dead zone element in situations with positive and negative velocities, wherein, advantageously, a value, e.g., the absolute value or a quadratic norm or another norm, of the negative dead zone limit is selected to be greater than a specified maximum value of the measurement noise of the measurement velocity, so that the dead zone velocity assumes a value of zero for values of the measurement velocity between the negative dead zone limit and the positive dead zone limit, and assumes the value of the measurement velocity for values of the measurement velocity lying below the negative dead zone limit and lying above the positive dead zone limit.

In order to ensure simple parameterization even in cases of using a negative dead zone limit, it can be provided in an advantageous manner to assign the same absolute value to the negative dead zone limit and the positive dead zone limit. In this way, as before, only a single value must be selected for parameterizing the dead zone element, and it is also ensured that the dead zone element influences positive and negative values of the measurement velocity in the same way.

In a further advantageous embodiment, it can be provided that the dead zone velocity provided by the dead zone element be subjected to low-pass filtering before it is fed to the velocity controller as the actual velocity, for example, in order to suppress undesirable frequency ranges at the actual velocity, e.g., resonant frequencies. In this context, it must be emphasized that the effect of a dead zone element according to the invention cannot be realized by one of the high- or low- or band-pass filters, since it is usually not possible to ensure that the measurement noise in the entirety of all frequencies or frequency bands occurring in the measurement noise is completely eliminated by such filters, which, however, is necessary for the intended stability in the present case.

It is also often advantageous to map all values of the measurement velocity below the value zero to a dead zone velocity with the value zero. In situations in which typically only positive velocities or only velocities in only one direction occur, a particularly simple implementation of the dead zone element according to the invention can be ensured in this way, since in this case, only a single value—specifically, the positive dead zone limit—has to be specified, and a comparison has to be made only with this value to determine which values of the measurement velocity are to be mapped to a dead zone velocity with the value zero.

In the context of the present embodiments, the maximum value of the measurement noise of the measurement velocity plays an important role, since, as described, the selection of the dead zone limits to be specified depends on this maximum value. The maximum value of the measurement noise is often already known, for example, from data sheet specifications or as an empirical value or from past measurements. However, in an advantageous manner, the maximum value of the measurement noise of the measurement velocity can also be (newly) determined or defined, for example, by an identification measurement when the multi-body system is at a standstill, wherein the time signal of the measurement velocity is recorded during a specified identification measurement interval, and the greatest value in terms of magnitude of the recorded time signal of the measurement velocity is determined as the maximum value of the measurement noise of the measurement velocity. Such an identification measurement can be carried out, for example, in a standstill phase during operation of the multi-body system, or else in a standstill phase before the start of operation of the multi-body system, and the dead zone limits can be adapted to newly identified maximum values of the measurement noise of the measurement velocity.

On the basis of a new identification of the maximum value of the measurement noise, it can be ensured that the maximum value of the measurement noise used for parameterizing the dead zone element is always correct and accurate, and that destabilizing measurement noise is not fed back in the velocity control loop anyway despite the existing dead zone element—for example, because the dead zone limits are suddenly selected to be too small in terms of magnitude due to changes, for example, in the measurement noise. Particularly in the case of velocity control loops, which are subjected to loads and thus wear and aging, the measurement noise occurring can change over time, and also electromagnetic disturbances or interference can have a negative effect in this connection. In such scenarios, it is often found to be particularly advantageous in some scenarios to identify and thus update the maximum value of the measurement noise even during operation.

Furthermore, embodiments are directed to a control system or a control loop for the standstill control of a multi-body system in which a velocity determination unit is provided which is designed to determine a velocity of a body of the multi-body system as a measurement velocity that is subject to a measurement noise and to provide the determined measurement velocity to a dead zone element according to the invention, wherein the dead zone element, as mentioned, is designed to provide the dead zone velocity to the velocity controller as the actual velocity for controlling.

In an advantageous manner, the dead zone element can here be designed as a part of the velocity determination unit.

It can also be provided to implement a quantization of the measurement velocity by means of the dead zone element, wherein the quantization is greater than the maximum value of the measurement noise of the measurement velocity, so that the quantized measurement velocity corresponds to the dead zone velocity.

Other exemplary embodiments and advantages of the present invention may be ascertained by reviewing the present disclosure and the accompanying drawing.

### BRIEF DESCRIPTION OF THE DRAWINGS

The present invention is described in greater detail below with reference to FIGS. 1 through 7, which show schematic and non-limiting advantageous embodiments of the invention by way of example. In the figures:

FIG. 1 shows a velocity control loop for a two-body system according to the prior art;

FIG. 2 shows a two-body system which has degenerated into a bound one-body system;

FIG. 3 shows a velocity control loop according to the invention with a dead zone element for a two-body system;

FIG. 3A shows a dead zone element according to the invention;

FIG. 4 shows a cascade of a superordinate position controller and an underlying velocity control loop according to the invention for an exemplary two-body system;

FIG. 5 shows a series connection of a quantization element, a differentiator, and a dead zone element;

FIG. 6 shows a series connection of a quantization element and a differentiator;

FIGS. 7A-7C show results achieved with a method according to the prior art; and

FIGS. 8A-8C show results in the velocity control of a multi-body system achieved with the method according to the invention.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

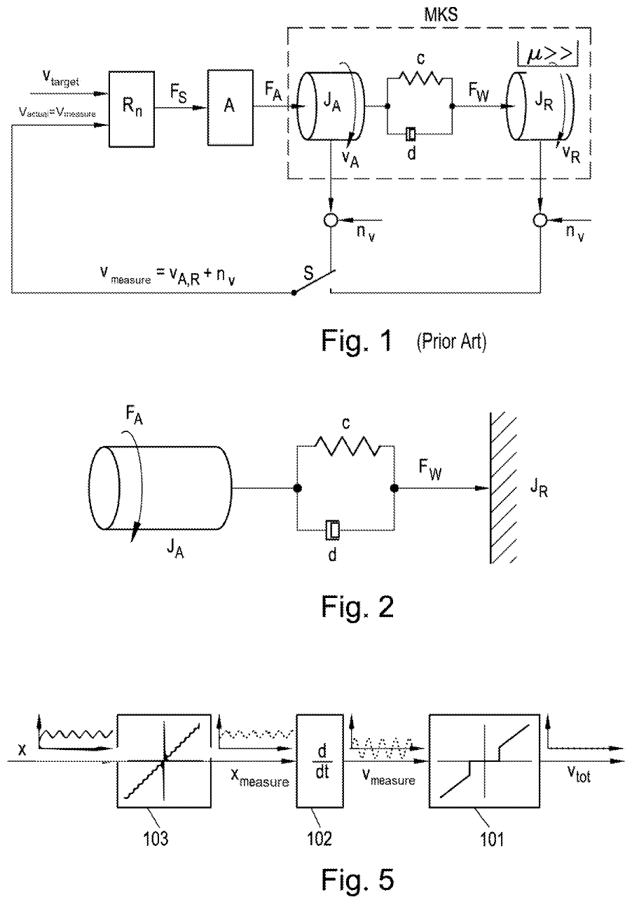

FIG. 1 shows a velocity control loop for controlling a velocity of a multi-body system MKS according to the prior art. In the case shown, a two-body system with two bodies J_{A}, J_{R} is assumed for the multi-body system MKS to be controlled. It should already be noted at this point that a multi-body system MKS, which is controlled by a velocity control loop as shown in FIG. 1, may also have more than two bodies J_{A}, J_{R} and may be provided, for example, as a three-, four-, or five-body system.

A multi-body system MKS as shown in FIG. 1 can be a rotary or a translatory multi-body system MKS. i.e., a multi-body system MKS whose bodies J_{A}, J_{R} perform translational movements or rotational movements. It is also possible for one body of the multi-body system MKS to move in a rotary manner and for another body to move in a translatory manner. Consequently, the generic terms, “body,” “velocity,” “force,” “shaft force,” etc., will be used in the following statements. However, with regard to rotary multi-body systems MKS, the analogous terms, “inertia,” “rotational speed” or “angular velocity,” “torque,” “shaft torque,” etc., shall also be comprised. Specific examples of multi-body systems MKS include drive axles of machine tools, drive trains, test stands with a loading machine and a test specimen connected to the loading machine via a mechanical shaft (e.g., an internal combustion engine to be tested), pressure rollers, or other multi-body systems MKS.

Specifically, the multi-body system MKS shown in FIG. 1 comprises a drive body J_{A} and friction body J_{R} which is mechanically coupled to the drive body J_{A}. In the present case, the mechanical coupling of the drive body J_{A} to the friction body J_{R} takes place via a spring element c and via a damper element d (corresponding to the usual designation of stiffness by “c” or damping by “d”). The spring element c and the damper element d thereby form an elastic, mechanical shaft. In a known manner, relative movements between the drive body J_{A} and friction body J_{R} result in shaft forces F_{W} transmitted via the spring element c and the damper element d, i.e., shaft forces F_{W} transmitted via the mechanical shaft formed by spring element c and via the damper element d, which in turn influence, in a known manner, the movements of the bodies J_{A}. J_{R}.

For the following considerations, it is important that a non-negligible static friction μ acts on the friction body J_{R}. A static friction μ can occur for the most varied reasons—for example, due to design-related reasons. For many reasons, the static friction μ acting on the friction body J_{R} can be significantly more pronounced than the sum of all of the frictions acting on the drive body J_{A}, which is also assumed below.

Regarding the drive body J_{A} and the friction body J_{R} mechanically coupled thereto, it is essential in the present connection that a driving force F_{A} determinable by a controller such as a velocity controller Rₙ act only on the drive body J_{A}, but in any case not on a friction body J_{R}. The movement of the friction body J_{R} is thus influenced only by the shaft force F_{W} transmitted via the mechanical shaft and by the static friction p. Also in embodiments with multi-body systems MKS having more than two bodies, it is decisive in the context of the present patent application that at least one body subject to static friction μ cannot be directly influenced by a drive force F_{A}.

According to the block diagram shown in FIG. 1, a velocity v_{A}, v_{R} is determined for each body J_{A}, J_{R}. Multiple possibilities for determining velocities are known in the prior art, which are sufficiently known to a person skilled in the field of drive technology—for example, by using encoders, such as rotary encoders or translational encoders. As explained in detail at a later point, it is irrelevant for the present invention exactly how a velocity processed in the velocity control loop is determined. A velocity can be measured directly in the context of the invention, e.g., by a velocity sensor which directly generates a velocity measurement signal and consequently no longer makes any further processing of a signal generated by a sensor necessary for determining a velocity measurement signal. However, in the context of the invention, a velocity can also be determined from a measured position signal, e.g., by differentiation, which is common in practice, or it can be calculated from other signals using observer technology sufficiently well-known from control technology, e.g., from measured electrical currents or voltages or from magnetic fluxes, etc. In this sense, the measurement velocity vₘₑₐₛᵤᵣₑ that is subject to measurement noise nᵥ can also be determined from a measurement signal of one of the bodies J_{A}, J_{R} of the multi-body system MKS—preferably from a measurement position xₘₑₐₛᵤᵣₑ or from another measurement signal, and in particular a measurement signal that is different from a velocity.

If necessary, one of the two determined velocities v_{A}, v_{R} can be selected by a switch S for a feedback in the control loop, which represents the case often arising in practice that measurement values from several bodies of a multi-body system MKS to be controlled are available, e.g., velocity measurement values and/or position measurement values, wherein ultimately only measured values of a single body can be used when controlling the multi-body system MKS. In many cases, “2-sensor systems” or “multi-sensor systems” are referred to, but this is irrelevant in the context of the present statements. In particular, it is also conceivable in the context of the invention that the velocity of only one body of the multi-body system MKS be determined. In the latter case, no switch S would be required either, of course.

In the present context, it is also important that a measured or determined velocity is subject to a measurement noise nᵥ, as is usual in practice. In FIG. 1, the superposition of the velocities v_{A}, v_{R} by the measurement noise nᵥ by summation points in the signal path of the velocity measurement is indicated. The measurement velocity vₘₑₐₛᵤᵣₑ subject to measurement noise nᵥ results in vₘₑₐₛᵤᵣₑ=v_{A,R}+nᵥ, depending on which of the velocities v_{A}, v_{R} is selected. Measurement noise nᵥ in this case is an interference variable with a broad, non-specific frequency spectrum. The causes of measurement noise nᵥ are sufficiently known to a person skilled in the art and can be attributable, for example, to thermal influences (heat noise, Johnson-Nyquist noise), current fluctuations (shot noise, Schottky noise), or electromagnetic interferences. The specific form of the measurement noise is irrelevant in the context of the present statements. The embodiments described below can accordingly be applied for a wide variety of types of noise, wherein the frequency characteristic (white noise, pink noise, etc.) is also irrelevant.

In the case shown in FIG. 1, a velocity v_{A}, v_{R} superimposed with measurement noise nᵥ is subsequently fed to a velocity controller Rₙ as actual velocity v_{actual} of the multi-body system MKS. In the case shown in FIG. 1, the actual velocity v_{actual} thus corresponds to the measurement velocity vₘₑₐₛᵤᵣₑ subject to measurement noise nᵥ. The velocity controller Rₙ determines from the actual velocity v_{actual} and from a specified target velocity v_{target} a control variable F_{S} for controlling the actual velocity v_{actual} to the target velocity v_{target}. It should be noted that, as is known, the control variable F_{S} determined by the speed controller Rₙ does not act directly on the multi-body system MKS—specifically, on the drive body J_{A}—and ultimately influence the velocity to be controlled, but that the control variable F_{S} determined by the speed controller Rₙ is first converted by an actuator A into a corresponding power variable F_{A}, i.e., into a real (drive) force, a real torque, a real current, such as a real drive current in to form a required drive force, etc.

For practical implementation, a velocity controller Rₙ can be realized on suitable microprocessor-based hardware, which preferably forms a control unit, such as, for example, on a microcontroller, or in an integrated circuit (ASIC, FPGA). The prior art also offers a variety of options for an actuator A for converting a control variable F_{S} (information signal) into a driving force F_{A} (power signal) such as servomotors or electric motors in general (asynchronous motor, synchronous motor, stepper motor), linear motors, hydraulic actuators, etc. As is customary in multi-body systems MKS driven by servomotors, a body of the multi-body system MKS can, for example, be a component of the servomotor—for example, its rotor. Said microprocessor-based hardware for implementing controllers, etc., can also be part of the servomotor and can be wired with said sensors or encoders or rotary encoders. These principles are well known to the person skilled in the art of control and/or drive technology, which is why these specifications are not discussed in more detail at this point.

In order to further explain the problem solved by the present invention in more detail, a topological change in the multi-body system MKS shown in FIG. 1 is shown in FIG. 2, which can occur in particular with vanishing target velocities. Vanishing target velocities v_{target}=0 can result due to a wide variety of reasons during operation of a multi-body system MKS—for example, from an operator's specification or from a specified target value profile. In the course of a so-called standstill control, a vanishing target velocity v_{target}=0 is again deliberately selected, in turn, to transfer the multi-body system MKS to the standstill and to keep it there for at least a specified period of time, which can be necessary, for example, for switch-on and/or switch-off processes.

As already stated earlier, a vanishing target value velocity v_{target}=0 and a vanishing actual velocity of v_{actual}=0 typically also result in vanishing control variables F_{S}=0 required by the velocity controller Rₙ. In the case of a velocity controller Rₐ which, as P controller, is designed with the controller gain kᵥ, the result would, for example, be F_{S}=kᵥ*(v_{target}−v_{actual})=0.

However, if the actual velocity v_{actual} is superimposed with measurement noise ne, the actual velocity v_{actual} fluctuates between values that are slightly different from zero, which results in different-from-zero control variables F_{S}=−kᵥ*nᵥ, different-from-zero drive forces F_{A}, and ultimately shaft forces F_{W} which are different from zero and transmitted via the mechanical shaft.

If, then, a static friction s, which is not overcome by the shaft force F_{W}, acts on the friction body J_{R} of the multi-body system MKS, the friction body J_{R} can remain in standstill despite a different-from-zero drive force F_{A} and despite a different-from-zero shaft force F_{W}. From the point of view of the velocity controller Rₙ, the friction body J_{R} thus behaves as a body with infinitely high inertia or infinitely high mass. The multi-body system MKS thus degenerates into a bound one-body system, as shown in FIG. 2.

Such a significant change in the multi-body system MKS to be controlled can lead to problems with regard to the stability of a control loop as shown in FIG. 1. In particular, if the velocity controller Rₐ has been designed on the basis of the original inertia of the friction body to be assumed in normal operation, i.e., not in standstill, a significant deviation between model assumption for the controller design and real behavior results at standstill.

A loss of stability occurring on the basis of the above statements can manifest itself in different ways, e.g., through so-called limit cycles: The controlled multi-body system MKS loses the stability at standstill and oscillates, i.e., the control variable F_{S}, driving force F_{A}, and velocity v_{actual} to be controlled increase until the shaft force F_{W} exceeds the static friction μ acting on the friction body J_{R}. The multi-body system MKS then behaves again as originally assumed, i.e., as a free two-body system, whereby stability is again established. However, if the specification of a vanishing target velocity v_{target}=0 remains unchanged, the velocity controller Rₙ transfers the multi-body system MKS to standstill again, resulting again in a loss of stability. For obvious reasons, this behavior is undesirable and manifests itself, for example, in the form of noise, thermal heating, and strong mechanical stress on the mechanics.

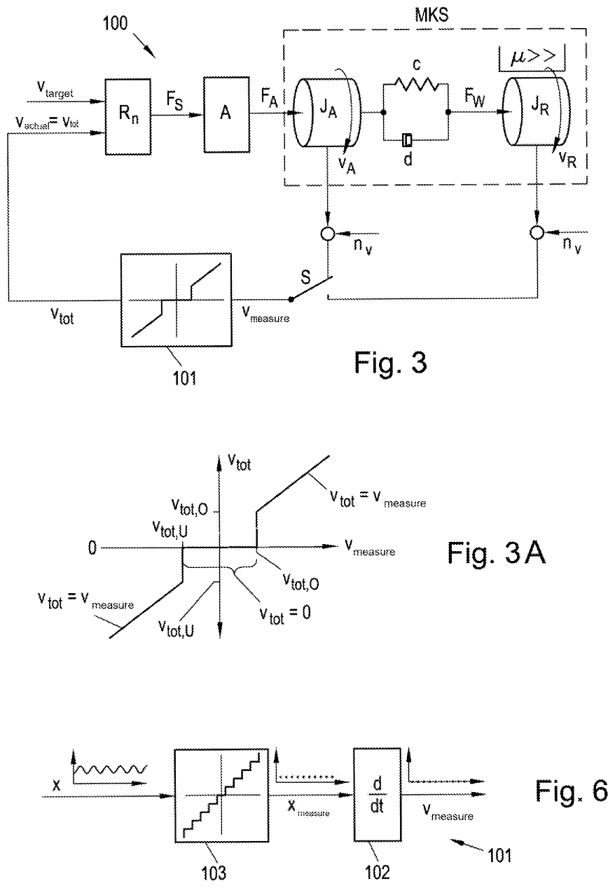

In particular, the described problem of stability loss is avoided by the present invention, as explained below with reference to FIG. 3. FIG. 3 shows a velocity control loop 100 according to the embodiments, which also controls a multi-body system MKS in the form of a two-body system, as discussed in the context of FIG. 1. All statements presented in relation to FIG. 1 regarding multi-body system MKS, drive body J_{A}, friction body J_{R}, velocity controller Rₙ, measurement of velocity v_{A}, v_{R}, static friction μ, realization of controllers, etc., are valid unchanged with regard to FIG. 3.

The velocity control loop 100 according to the invention shown in FIG. 3 differs from the control loop shown in FIG. 1 by a dead zone element 101 for the measured velocity provided in the feedback path. By the velocity control loop 100 according to the invention, it is provided for measuring a velocity of one of the bodies J_{A}, J_{R} of the multi-body system MKS as a measurement velocity vₘₑₐₛᵤᵣₑ that is subject to a measurement noise n and providing it to the dead zone element 101. According to the invention, the dead zone element 101 of the multi-body system MKS ensures that the dead zone velocity vₜₒₜ assumes the value zero for values of the measurement velocity vₘₑₐₛᵤᵣₑ above zero and below a positive dead zone limit v_{tot,O}, and assumes the value of the measurement velocity vₘₑₐₛᵤᵣₑ for values of the measurement velocity vₘₑₐₛᵤᵣₑ above the positive dead zone limit v_{tot,O}.

In order to ensure that the destabilizing influence of measurement noise nᵥ is suppressed, the positive dead zone limit v_{tot,O} must be selected greater than a specified or known maximum value of the measurement noise nᵥ of the measurement velocity vₘₑₐₛᵤᵣₑ. However, to keep the influence of the dead zone element on the control loop 100 nevertheless as low as possible, the positive dead zone limit v_{tot,O} can be selected to be less than one-hundred times the maximum value of the measurement noise nᵥ, or less than ten times the maximum value of the measurement noise nᵥ, or, preferably, can be selected to be less than five times the maximum value of the measurement noise nᵥ, or, particularly preferably, can be selected to be less than twice the maximum value of the measurement noise nᵥ. The dead zone velocity vₜₒₜ output by the dead zone element 101 is subsequently fed to the velocity controller Rₙ as actual velocity v_{actual} for controlling.

The maximum value of the measurement noise nᵥ is known for a specific encoder or rotary encoder or measuring sensor or, generally, for a specific velocity determination unit for measuring or determining the velocity, e.g., from a data sheet, or can at least be determined by measurement.

By the dead zone element 101 according to the embodiments, the velocity control loop 100 is separated into standstill phases. Since, as a result, no closed control loop is present at standstill, there consequently can also be no closed control loop present anymore that, in accordance with the above statements, loses its stability. The dead zone element 101 according to the embodiments thus solves the described stability problem in a simple and effective manner.

A consequence of the procedure according to the embodiments, however, is that the velocity controller Rₙ provided in the velocity control loop 100 acts in a feed forward path without feedback during the standstill phases. For control engineering reasons (such as, in particular, for ensuring the bounded-input-bounded-output (“BIBO”) stability of the forward path, it can be advantageous here to use control laws without integral component as velocity controller Rₙ. These examples may be defined as sliding mode controllers, or backstepping controllers, or model predictive controllers, or P-controllers, or flatness-based controllers. However, the specific choice of the control law is irrelevant in the implementation of the present invention. A switchover of the control law in the velocity controller Rₙ during the standstill phases to a control law without integral component is, basically, also conceivable.

In practice, situations often arise in which positive and negative velocities occur, e.g., bodies moving in a positive and in a negative direction or rotating in a positive and a negative direction of rotation. In such cases, a negative dead zone limit v_{tot,U} can be provided in the dead zone element 101 in a preferred manner, wherein the absolute value of the negative dead zone limit v_{tot,U} is selected to be greater than a specified maximum value of the measurement noise nᵥ of the measurement velocity vₘₑₐₛᵤᵣₑ so that the dead zone velocity vₜₒₜ assumes the value zero for values of the measurement velocity vₘₑₐₛᵤᵣₑ between the negative dead zone limit v_{tot,U} and the positive dead zone limit v_{tot,O}, and assumes the value of the measurement velocity vₘₑₐₛᵤᵣₑ for values of the measurement velocity vₘₑₐₛᵤᵣₑ below the negative dead zone limit v_{tot,U} and above the positive dead zone limit v_{tot,O}. In this case, two parameters are required for parameterizing the dead zone element 101—a negative dead zone limit v_{tot,U} and the positive dead zone limit v_{tot,O}. The characteristic of such a dead zone element 101 is shown in FIG. 3a.

To keep the influence of the dead zone element on the control loop 100 as low as possible in this embodiment, the negative dead zone limit v_{tot,U} can be selected to be greater than minus one-hundred times the maximum value of the measurement noise nᵥ, or greater than minus ten times the maximum value of the measurement noise nᵥ, or it can be selected to be greater than minus five times the maximum value of the measurement noise nᵥ, or it can be selected to be greater than minus two times the maximum value of the measurement noise nᵥ.

In an advantageous embodiment, the dead zone element 101 can be designed symmetrically, in that values with a different sign, but the same absolute value, are used for the negative dead zone limit v_{tot,U} and the positive dead zone limit v_{tot,O}.

In other cases relevant in practice, e.g., in applications on (motor) test benches, it can again be advantageous to map all negative measurement velocities vₘₑₐₛᵤᵣₑ to the value zero. In the context of the present invention, this can be achieved by assigning the value zero to the dead zone velocity vₜₒₜ for all values of the measurement velocity vₘₑₐₛᵤᵣₑ below the positive dead zone limit v_{tot,O}.

It should be noted that the dead zone element 101 provided according to the embodiments cannot be replaced by any type of filter, such as a low-pass filter or a high-pass filter or a band-pass filter. In order to be able to solve the described stability problem, it is essential that the measurement noise nᵥ contained in the measurement velocity vₘₑₐₛᵤᵣₑ be completely eliminated. A filter as mentioned above can typically not ensure that entire frequency bands (noises usually extend over a plurality of frequencies, i.e., to expanded frequency bands) are eliminated, i.e., that entire frequency bands are amplified continuously with a gain of zero. Nevertheless, in the practical application of the invention, it may be advantageous to subject the dead zone velocity vₜₒₜ to filtering, e.g., a low-pass filtering, before using it in the velocity controller for determining the target drive force Fₛ, but this is due to the design of the controller or of the entire control loop, and is not related to the stability problem at issue.

As described, the dead zone element 101 is provided in the feedback path of the velocity control loop 100 and can be configured by means of at least one parameter—specifically, at least by the positive dead zone limit v_{tot,O}. As will be explained in detail below, the parameterization or configuration of the dead zone element 101 according to the invention is of essential importance.

If, according to the preceding statements, a negative dead zone velocity v_{tot,U} and a positive dead zone velocity v_{tot,O} are provided as parameters of the dead zone element 101, a maximum value of a measurement noise n superimposed on the velocity n to be controlled can be selected as the lower limit for the absolute value of these parameters, as mentioned. In turn, to determine this maximum value of the measurement noise nᵥ, in a particularly advantageous embodiment of the invention, one or more identification measurements can be carried out—preferably when the multi-body system MKS is at a standstill.

In the course of an identification measurement when the multi-body system MKS is at a standstill, and preferably before the start of the operation of the multi-body system MKS. i.e., preferably before the start of the velocity control of the multi-body system MKS, the time signal of the measurement velocity vₘₑₐₛᵤᵣₑ can be recorded, and the greatest value of the recorded time signal of the measurement velocity vₘₑₐₛᵤᵣₑ in terms of magnitude can be identified as the maximum value of the measurement noise nᵥ of the measurement velocity vₘₑₐₛᵤᵣₑ during a specified identification measurement interval. It is also possible to identify the largest positive value or the largest negative value of the recorded time signal of the measurement velocity vₘₑₐₛᵤᵣₑ as the maximum value of the measurement noise nᵥ of the measurement velocity vₘₑₐₛᵤᵣₑ.

In a further advantageous embodiment of the invention, however, an identification measurement can also be carried out during operation of the velocity control loop, i.e., during operation of the multi-body system MKS. Preferably, standstill phases occurring during operation of the multi-body system MKS are detected and used as identification measurement intervals for identifying a maximum value of the measurement noise nᵥ. In this way, it can be ensured that the dead zone limits v_{tot,O}, v_{tot,U} used for parameterizing the dead zone element 101 are always adapted to current maximum values of the measurement noise nᵥ. The dead zone limits v_{tot,O}, v_{tot,U} can also be specified, for example, by an operator, or, for example, determined from a data sheet specification of a rotary encoder, or read out from a table. Such a table can be stored on the microprocessor-based hardware, on which, for example, the dead zone element 101 and the velocity controller Rₙ are implemented.

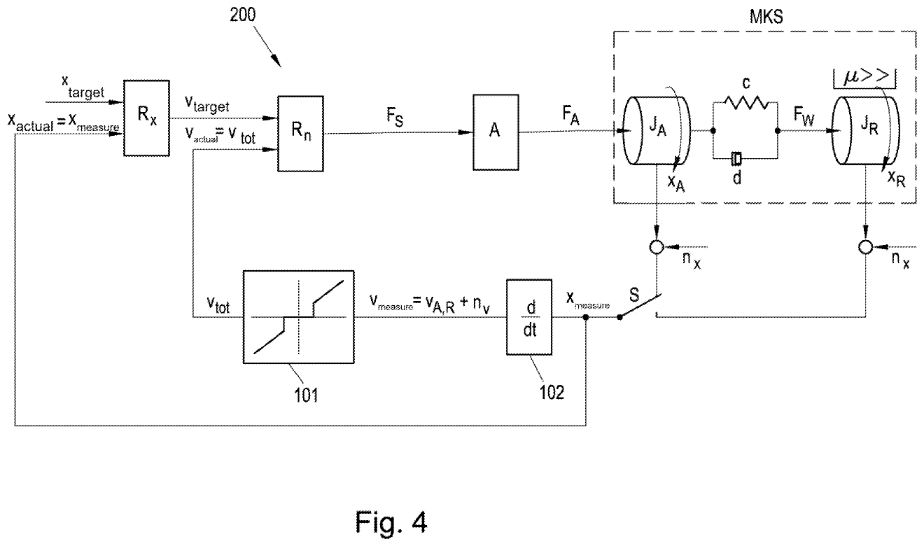

A velocity control loop 100, as discussed with reference to FIG. 1 and FIG. 2, is known to be used not only to control a velocity v exclusively. Rather, a velocity control loop 100 can also be a component of a comprehensive control concept, e.g., a component of a cascaded position control loop 200, in which the velocity control loop 100, as a subordinate control loop, implements velocity target values v_{target} which are specified by a superimposed position controller Rₓ. Such a position control loop 200, for which the above statements relating to multi-body system MKS, actuator A, and velocity controller Rₙ are also valid in full, is shown in FIG. 4. Specifically, a position controller Rₓ can determine from a specified target position x_{target} and from an actual position x_{actual} the target velocity v_{target} fed to the velocity controller Rₙ for controlling the actual velocity v_{actual}. For example, for the case of a position control loop 200, in which P-controllers are used both as position controllers Rₓ and as velocity controllers Rₙ, and in which the actuator dynamics of the actuator A can be described with sufficient accuracy as a PT1 element, it was found that the controller gain kₚ of the position controller Rₓ at standstill, i.e., when the two-body system degenerates into a bound one-body system, would have to satisfy the very restrictive equation

$${k}_{p} < \frac{d}{{J}_{A}}$$

(with damping of the mechanical coupling d and inertia of the actuator body J_{A}) to avoid stability problems even without a dead zone element 101 according to the invention. Advantageously, the present invention can also be used in such a scenario and without the limitation to the controller gain kₚ of the position controller Rₓ.

FIG. 4 also shows a further important aspect of the present invention. In many practically relevant cases, as in the situation shown in FIG. 4, velocities are not measured directly, but a position measurement is first carried out, and the velocity of interest is determined from the measured position by differentiation. In FIG. 4, the positions x_{A}, x_{R} are detected by a position encoder. The detected position measurement signals are, like the velocities already discussed in detail, superimposed by noise nₓ. By the switch S, one of the position measurement signals is again selected for feedback. It should be noted here that different position measurement signals can also be used for feedback of a position in the position control loop and for determination of a velocity in the velocity control loop, e.g., by differentiation, wherein suitable switches can be provided in the same way for selecting the position measurement signals. For example, a first position measurement signal x_{A} of the drive body J_{A} can thus be used to calculate the velocity, and a second position measurement signal x_{R} of the friction body J_{R} can be fed back in the position control loop, or vice versa.

The variant shown in FIG. 4 illustrates the already mentioned circumstance that, in the context of the present invention, irrespective of the specific embodiment, it is not important how a velocity controlled in the velocity control loop is actually determined. A velocity can thus be measured directly by means of a suitable velocity determination unit, e.g., an encoder or a rotary encoder, or it can also be determined from a position measurement signal in a velocity determination unit—for example, by differentiation. However, it is equally possible in the context of the invention to determine a velocity by calculation from another or several other signals—for example, when using electrical machines as actuators from measured currents and/or measured voltages and/or measured magnetic fluxes. For this purpose, the observer technology sufficiently known from control technology can be used, and, for example, a Kalman filter or a Luenberger observer or a sliding mode observer be used for determining a velocity.

Specifically, in the embodiment shown in FIG. 4, the selected position measurement signal is differentiated in a differentiator 102, so that, as in the case without superimposed position controller Rₓ, a measurement velocity vₘₑₐₛᵤᵣₑ that is subject to measurement noise nᵥ is produced for velocity control. Because the dead zone element 101 acts only in the underlying velocity control loop, the invention does not result in any influencing of superimposed control loops in such scenarios, such as the superimposed object control loop 200 in question.

Following on from the above considerations. FIG. 5 shows a further aspect of the embodiments which is particularly important for practical implementation. For this purpose, FIG. 5 shows a series connection of blocks, as can occur, for example, in the context of an embodiment as discussed in FIG. 4 for determining velocities (as is customary in control technology, the specific implementation of measurements in the block diagrams from FIG. 1, FIG. 3, and FIG. 4 is not explicitly shown for reasons of clarity). The series connection shown in FIG. 5 forms a velocity determination unit. In the present context, a velocity determination unit is to be understood as a general unit for determining velocities which, according to the above statements, can comprise only one velocity sensor, but also sensors for measuring other signals and, for example, an observer for calculating the velocity of interest from these other signals. The dead zone element 101 is thus part of the velocity determination unit in the exemplary case shown in FIG. 5. However, a dead zone element 101 can of course also be arranged outside a velocity detection unit.

In the exemplary velocity determination unit shown in FIG. 5, a quantization element 103 is first shown. The quantization element 103 represents the quantization unavoidable when producing digital measurement values. Specifically, the quantization element 103, from a sensor signal x, which has been generated, for example, by photoelectric scanning of a grid moving with a body J_{A}, J_{R} of the multi-body system MKS (cf., for example, EP 3355032 B1), generates a quantized position measurement signal xₘₑₐₛᵤᵣₑ. It is assumed here that the measurement noise nₓ, which is essential in the present context, already acts on the sensor signal x and brings about an oscillation in the sensor signal x.

If a quantization element 103 with high resolution is now used, i.e., with small quantization steps, the oscillation in the sensor signal x is not blocked and is mapped almost unchanged to the position measurement signal xₘₑₐₛᵤᵣₑ. Due to the subsequent differentiation for generating the measurement velocity vₘₑₐₛᵤᵣₑ in block 102, the oscillation caused by the noise is further amplified and, of course, remains part of the measurement velocity vₘₑₐₛᵤᵣₑ. As in the above statements, a measurement velocity vₘₑₐₛᵤᵣₑ that is subject to measurement noise nᵥ is formed. Only the following dead zone element leads to the suppression of these signal components caused by the noise nₓ, which brings about the desired stabilization of the control loop.

If, however, as shown in FIG. 6, a quantization element 103 is now used which, compared to the quantization element 103 of FIG. 5, has a substantially poorer resolution or substantially coarser quantization levels, e.g., coarser by a factor of 2 or by a factor of 5 or by a factor of 10, the oscillation caused by the measurement noise nₓ in the sensor signal x is suppressed. This means that the effect of the dead zone element 101 according to the embodiments can be realized through a quantization element 103 which is deliberately equipped with a particularly large quantization, and preferably with quantization steps that are selected to be greater than a specified maximum value of a measurement noise nᵥ. According to FIG. 6, the dead zone element 101 according to the embodiments will be implemented as a series connection of a quantization element 103 with poorer. i.e., larger, resolution, viz., with a resolution that suppresses the acting measurement noise nₓ, and a differentiator 102. If a velocity sensor (rotary encoder) is available that provides direct velocity measurement values, a deliberately large resolution can of course also be provided for a velocity sensor, in order to suppress the destabilizing effect of measurement noise as described. In other words, in the embodiment according to FIG. 6, the dead zone element according to the embodiments implements a quantization of a measurement signal, wherein the quantization of the measurement signal is larger than the maximum value of a measurement noise, and preferably of a measurement noise of the measurement velocity, so that the quantized measurement velocity vₘₑₐₛᵤᵣₑ corresponds to the dead zone velocity vₜₒₜ.

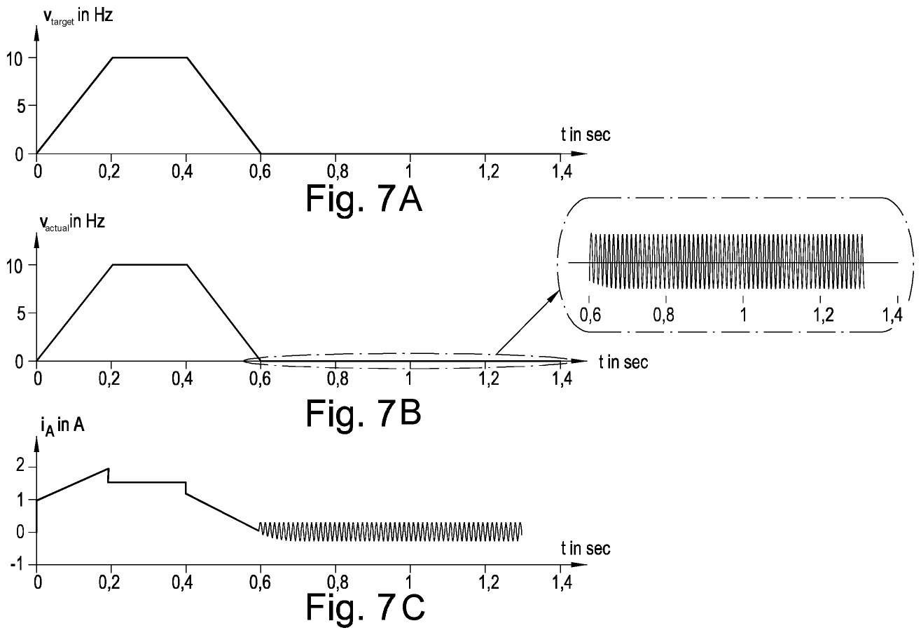

FIGS. 7A-7C, finally, show a limit cycle as can occur during operation of a velocity control loop according to the prior art as shown in FIG. 1. Specifically. FIG. 7A first shows a specified time course of the target velocity v_{target}, in which first a ramp-shaped increase and a ramp-shaped decrease in the target velocity v_{target} are provided. Although a target velocity of v_{target}=0 is required as of time t=0.6 seconds, the stability problem described in detail causes an oscillation, which on the one hand can be seen in the measurement velocity vₘₑₐₛᵤᵣₑ shown in FIG. 7B, and on the other affects the drive current i_{A} shown in FIG. 7C. The drive current i_{A} in this case stands for a force-forming electrical current which the actuator A in the form of an electrical machine, e.g., a synchronous machine or an asynchronous machine or a reluctance machine or a DC machine, forms, in order to implement the control variable required by the superordinate velocity controller Rₙ.

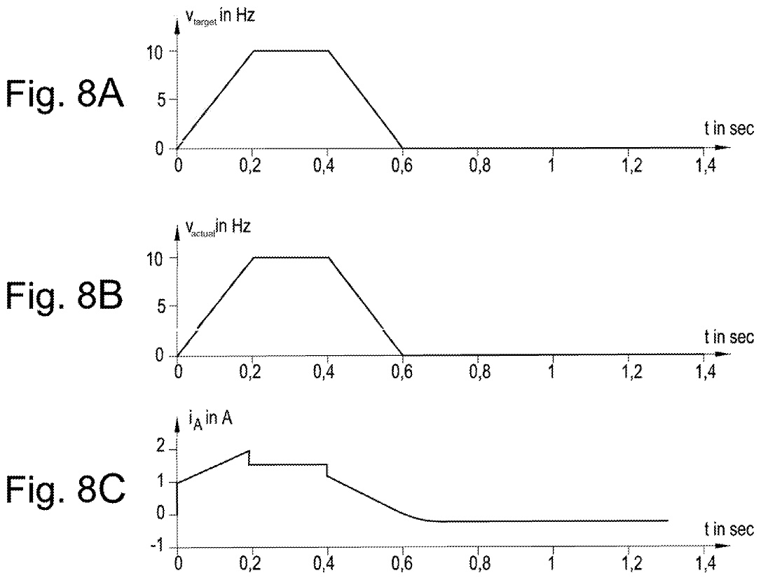

The present invention makes it possible to avoid such undesirable phenomena, which is shown in FIGS. 8A-8C. The dead zone element 101 inserted according to the embodiments makes it possible in the manner described to ensure the stability of the velocity control loop throughout and to prevent the oscillation described with reference to FIG. 7 or the limit cycle described with reference to FIG. 7. The result is oscillation-free time signals of both the measurement velocity vₘₑₐₛᵤᵣₑ and said current i_{A}.

In summary, the present embodiments are accompanied by a series of advantages which are valuable in practice. For example, the embodiments represent a simple possibility for avoiding limit cycles in drive systems. The dead zone element 101 provided according to the invention is simple to parameterize, since typically no more than two parameters, or in the case of a symmetrical design of the dead zone element 101, even only one parameter, have to be defined. Furthermore, the embodiments do not require any design changes in the multi-body system MKS, is usable in the context of both a 1- and a 2-encoder control, does not bring about a loss of accuracy in the actual position, prevents an acoustic interference, and reduces thermal load on actuators used for the implementation of the control variables required by the velocity controllers Rₙ.

The microprocessor-based hardware and/or integrated circuits described above can be implemented digitally, as software on microprocessor-based hardware. Thus, the control unit may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies, and/or analog instrumentation, e.g., analog electric/electronic circuits, analog computers, analog devices, etc. Further, the processing of data and processing/transmission of control signals can be implemented via microprocessors or similar components, programmed using software (e.g., microcode) to perform various functions discussed herein and may optionally be driven by firmware and/or software, or alternatively, implemented by dedicated hardware, or as a combination of dedicated hardware to perform some functions and a processor (e.g., one or more programmed microprocessors and associated circuitry) to perform other functions.

Moreover, the system can also include at least one memory (not shown), e.g., a non-transitory computer readable medium or media, to store one or more sets of instructions to perform any of the methods or computer-based functions disclosed herein, and at least one processor that can access the at least one memory to execute the one or more sets of instructions to perform any of the methods or computer-based functions discussed above. Moreover, the at least one memory and/or the at least one processor can be located on a remotely located server, memory, system, or communication network or in a cloud environment.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for standstill control of a multi-body system (MKS) having at least one drive body, at least one friction body mechanically coupled to the drive body, a velocity controller to determine, from a specified target velocity v_{target}=0 and from an actual velocity of the MKS, a control variable for controlling the actual velocity to the target velocity, and an actuator to convert the control variable into a drive force acting on the drive body, wherein a static friction acts on the friction body, the method comprising:
determining a velocity of one of the at least one drive body or the at least one friction body as measurement velocity subject to a measurement noise; and
feeding the measurement velocity to a dead zone element, wherein the dead zone element converts the measurement velocity to a dead zone velocity which:
assumes a value of zero for values of the measurement velocity above a value of zero and below a positive dead zone limit, or
assumes the value of the measurement velocity for values of the measurement velocity above the positive dead zone limit,
wherein the positive dead zone limit is selected to be greater than a specified maximum value of the measurement noise of the measurement velocity, and
feeding the dead zone velocity to the velocity controller as the actual velocity.

2. The method according to claim 1, wherein a negative dead zone limit is provided in the dead zone element, wherein an absolute value of the negative dead zone limit is greater than a specified maximum value of the measurement noise of the measurement velocity, so that the dead zone velocity assumes a value zero for values of the measurement velocity between the negative dead zone limit and the positive dead zone limit, and assumes the value of the measurement velocity for values of the measurement velocity below the negative dead zone limit and above the positive dead zone limit.

3. The method according to claim 2, wherein the negative dead zone limit and the positive dead zone limit have a same absolute value.

4. The method according to claim 1, wherein the dead zone element converts the measurement velocity to a dead zone velocity which assumes the value of zero for values of the measurement velocity below the value zero.

5. The method according to claim 1, wherein the dead zone velocity is low-pass filtered before it is fed to the velocity controller as actual velocity.

6. The method according to claim 1, wherein the maximum value of the measurement noise of the measurement velocity is determined by an identification measurement when the MKS is in standstill,
wherein, during a specified identification measurement interval, a time signal of the measurement velocity is recorded, and a greatest absolute value of the recorded time signal of the measurement velocity is determined as a maximum value of the measurement noise of the measurement velocity.

7. The method according to claim 6, wherein the maximum value of the measurement noise of the measurement velocity is re-determined in a standstill phase during operation of the MKS, and
wherein the positive dead zone limit and/or the negative dead zone limit are adjusted to the re-determined maximum value of the measurement noise.

8. The method according to claim 6, wherein the maximum value of the measurement noise of the measurement velocity is determined in a standstill phase before the start of operation of the MKS.

9. The method according to claim 1, wherein a velocity controller without integral component is used for controlling the actual velocity.

10. The method according to claim 1, wherein the measurement velocity that is subject to a measurement noise is measured directly.

11. The method according to claim 1, wherein the measurement velocity that is subject to a measurement noise is determined from a measurement signal, preferably from a measurement position (xₘₑₐₛᵤᵣₑ), from one of the bodies of the MKS.

12. The method according to claim 1, wherein a position controller is provided, which, from a specified target position and from an actual position, which describes a position of one of the bodies of the MKS, determines the target velocity fed to the velocity controller controlling the actual velocity.

13. A control system for standstill control of a MKS having at least one drive body and a friction body mechanically coupled to the drive body, the control system comprising:
a control unit on which a velocity controller is implemented, the velocity controller being designed to determine, from a specified target velocity v_{target}=0 and from an actual velocity of the MKS, a control variable for adjusting the actual velocity to the target velocity;
an actuator designed to convert the control variable into a drive force acting on the drive body, wherein a static friction acts on the friction body;
a velocity determination unit designed to determine a velocity of one of the at least one drive body or the at least one friction body as a measurement velocity subject to a measurement noise and to feed the determined measurement velocity to a dead zone element designed to convert the measurement velocity into a dead zone velocity,
wherein the dead zone velocity:
assumes a value of zero for values of the measurement velocity above a value of zero and below a positive dead zone limit, or
assumes the value of the measurement velocity for values of the measurement velocity above the positive dead zone limit,
wherein the positive dead zone limit is selected to be greater than a specified maximum value of the measurement noise of the measurement velocity, and
wherein the dead zone element is designed to feed the dead zone velocity to the velocity controller as the actual velocity for controlling.

14. The control system according to claim 13, wherein the dead zone element is designed as a part of the velocity determination unit.

15. The control system according to claim 13, wherein the dead zone element is configured to implement a quantization of the measurement velocity, wherein the quantization is greater than the maximum value of the measurement noise of the measurement velocity so that the quantized measurement velocity corresponds to the dead zone velocity.
